(19) United States
(12) Patent Application Publication
(10) Pub. No.: US 2010/0045043 A1
(43) Pub. Date: Feb. 25, 2010

(54) SYSTEM FOR GENERATING ELECTRIC POWER

(76) Inventor: Joseph Gostner, Bolzano (IT)

Correspondence Address: HEDMAN & COSTIGAN P.C., 1185 AVENUE OF THE AMERICAS, NEW YORK, NY, 10036, US

(21) Appl. No.: 12/450,032

(22) PCT Filed: Mar. 10, 2008
(86) PCT No.: PCT/IB2008/000635

§ 371 Date: Oct. 7, 2009

(30) Foreign Application Priority Data
Mar. 12, 2007 (IT) MI2007A000489

(51) Int. Cl. F03B 13/00

(52) U.S. Cl. 290/52; 290/54

(57) ABSTRACT

System for generating electric power characterised in that it comprises a line of turbines including a plurality of horizontal axis turbine devices (2), connectable to each other and positioned in a liquid current which determines its rotation, a support structure, comprising float devices (5) adapted to keep such line at a submerged operating position.

Furthermore, the system comprises, rotation transmission devices which transfer the turbine movement to a surface means (8) provided with at least one electric generator connected to said line.

The present invention refers to a system for generating electric power.

In particular, the present invention refers to a system for generating electric power which exploits a flowing water current (for example marine or river currents) which is capable of rotating a device for converting the kinetic energy of the water current into mechanical energy first and then into electric power using any kind of electric generator.

Known to the prior art are devices for generating electric power which exploit an air current such as for the example the so-called horizontal axis aerogenerators, that is devices provided with blades, connected to a hub whose rotation axis is parallel to the direction of the wind, which are rotated by the wind itself and which transmit their rotation to an electric generator.

Obviously, such structures have a natural geographic binding. In particular, such devices are efficient provided that they are installed in areas subject to constant and strong wind, such as for example islands or mountainous areas.

In such type of structures horizontal axis turbines are used frequently. Such turbines usually range from medium-small sizes (from 10 to 20 metres in diameter, with power from 20 up to 100 KW) to big 2 MW generators with an 80 m rotor.

The Applicant thought of how to operate a blade of such type in a liquid current, for example a underwater current. In particular, the applicant thought of how to make and position a turbine or a structure provided with several turbines in an environment in which it is capable of exploiting water currents for example, in the sea, in a river, in a canal etc, or anywhere else it is possible to exploit the motion of a liquid fluid. Generally, a horizontal axis turbine generates energy upon impact with a fluid current (air or water). The blades (which can be two, three or more), suitable designed, generate forces (aerodynamic in air and hydrodynamic in water) which provide a torque on the axis of the generator.

The torque, connected at a given speed of rotation, is converted into developed mechanical power. Such a power is then generally exploited through an electric generator which converts the mechanical energy into electric power.

An advantageous characteristic observable in the water currents with respect to the wind current lies in the density of the fluid (water weighs about 820 times more than water at an equal volume). As a matter of fact, the power extractable by means of a turbine is linked to the following equation:

P=η·(0.5·ρS·V³)

### Where:

η is the efficiency, variable between 0.20 and 0.40,

V is the velocity of the current,

ρ is the density of the fluid medium,

S is the surface affected by the rotor of the turbine (that is equivalent to the area of the circle with a diameter equivalent to the one of the rotor).

It is thus clear that, even with marine currents reaching 3-4 m/s (in the air velocities are typically 3 times greater), given that the water density is 820 times greater with respect to the one of the air, then the extractable power is (820/3³ =820/27=30.7) at least 30 times greater than the one extractable by means of a wind turbine of an equivalent dimension.

It is also clear that the forces in question are much greater and the structural dimensioning of the blades for marine rotors is considerably more complex with respect to the one related to the wind generator rotors.

The applicant provided a system for generating electric power comprising a plurality of horizontal axis turbine devices, connectable to each other to form at least one line of turbines positioned in a liquid current. Such a line is constrained to a support structure, comprising float devices adapted to keep such at least one line at an operating position. Rotation transmission devices transfer the movement of the turbines to a surface means, such as for example a ship or another suitable means.

Such surface means being adapted to accommodate at least one electric power generating device starting from the movement generated by the abovementioned turbines.

An aspect of the present invention regards a system for generating electric power according to the characteristics of the attached claim 1.

Further characteristics of the present invention shall be clear from the following description and from the annexed drawings, strictly provided for exemplifying and non-limiting purposes, wherein:

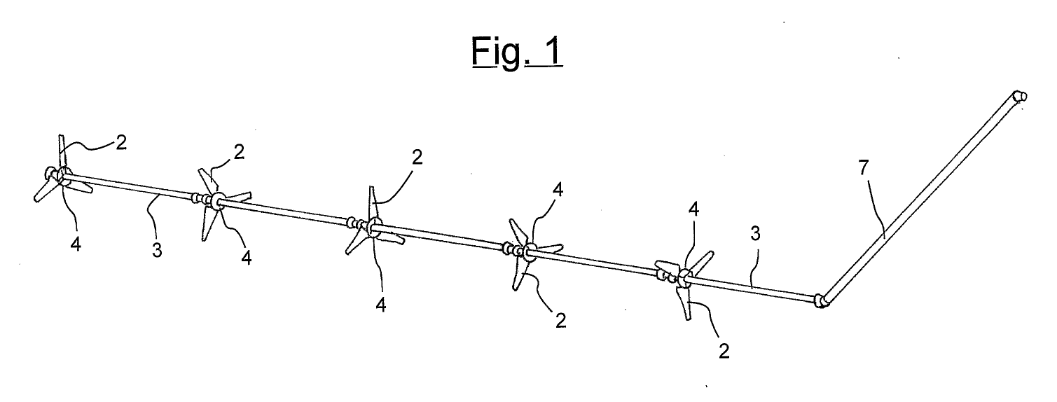

FIG. 1 schematically shows a single line comprising in an exemplifying manner five turbine devices according to the present invention;

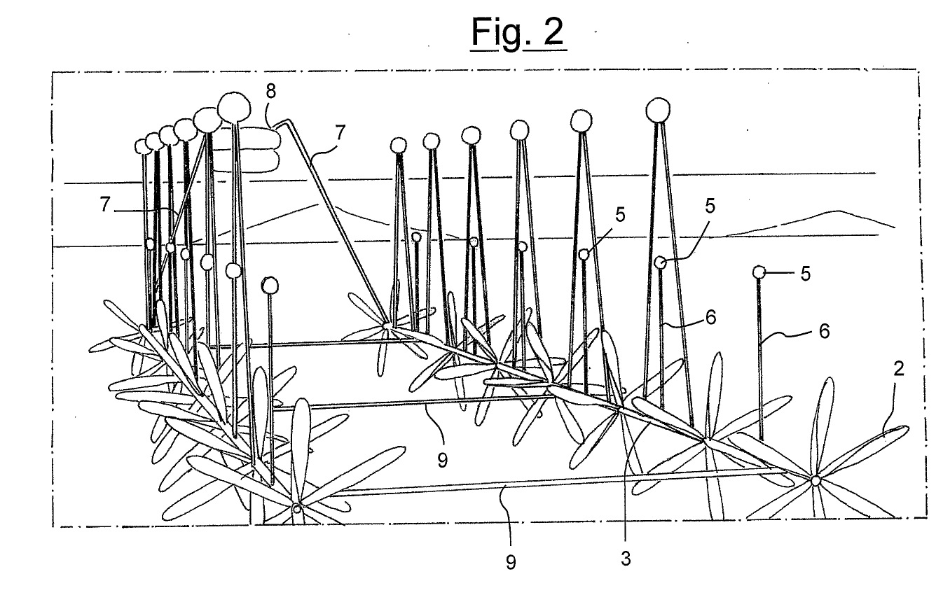

FIG. 2 schematically shows an embodiment of the system according to the present invention provided with two lines;

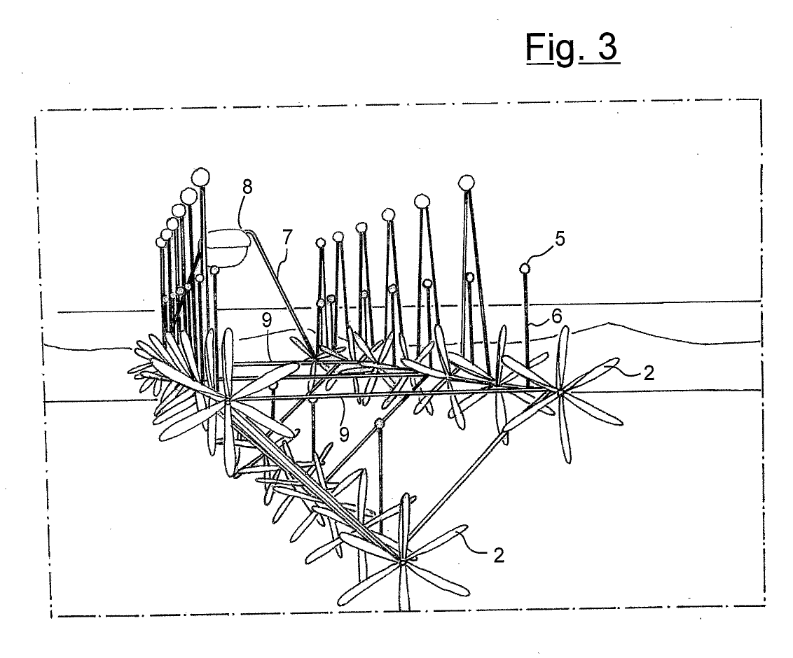

FIG. 3 schematically shows an embodiment of the system according to the present invention provided with three lines.

Referring to the abovementioned figures, the system in its entirety comprises one or more lines, each of which comprises a plurality of horizontal axis turbine devices 2 (for example with a diameter of the rotor indicatively between 40 and 60 m) mounted on a single articulated axis 3 made up of several pieces or sections connected to each other by means of suitable joints. Such an axis transmit motion and thus the torques and forces generated by the turbine.

Each turbine is rigidly connected to its axis by means of a hub 4. Each axis section is connected to the sections arranged ahead and behind it by means of cardan joints. The joints allow to make the system with several sections torsionally rigid, in such a manner to guarantee upstream transmission of the torque generated by each single turbine. At the same time, the cardan joints allow to provide a generally flexible chain and which can adapt to movements or misalignments (even temporary) for example due to a marine wave motion.

In such a manner, the line is easily arranged in a direction parallel to the direction of the current.

Furthermore, the system comprises a support structure, comprising float devices adapted to keep the line at an operating position. Preferably, each turbine device is supported by special float 5 which is connected to the axis by means of a line 6 connected to a bearing, in such a manner that the shaft can rotate freely with respect to the connection line with the float.

In conclusion, the turbines operate one behind the other. By arranging the turbines at a distance at least equivalent to 3 diameters from each other, the loss effects due to the wake would be reduced to 20-30%. In other words, the efficiency of the turbines arranged behind the first should be reduced by at least 20-30%. This would not drastically reduce the power generable by the system.

On the surface, the various floats are advantageously connected to each other through a series of rigid elements (for example pipes) and a series of articulations. The articulations (joints) of the floats should have a maximum rotation angle equivalent to 10°, in such a manner to avoid that the chain might lose the rectilinear arrangement in case of absence of current or even in case of inversion of the same.

Such a line (connected to the floats on the surface) through rotation transmission devices transfers the movement of the turbines to a surface means 8, for example a ship, comprising a cardan joint and a rigid tubular element 7, which is connected to an electric generator arranged on such a surface station.

The ship is conceived in such a manner to have a wide deck where all the lines and pipes could be accommodated before reaching the lines anchorage and laying site. Once it reaches the position and it is anchored, the entire line is lowered from the ship, one element at a time, with the help of suitable cranes.

Once all the lines are in the water, the rigid tubular elements 7 are connected to the electric generator (in turn anchored to the deck).

The system according to the present invention can provide for the presence of one or more lines. For example, FIG. 2 shows a two-lines system and FIG. 3 shows a three-lines system, each one connected to a suitable generator, which will allow a higher and more efficient generation of electric power through only one ship.

In case of a two-line system, the two lines could be advantageously arranged parallel to each other at the same depth. Advantageously, a three-lines system could be triangular configured, that is with two lines at the same depth and a third line positioned deeper than the other two.

Additionally, a possible four-lines system could be rectangular configured, that is with two parallel lines at the same depth and two parallel lines positioned deeper than the first two. In all cases having several lines, the lines can be advantageously connected to each other through a plurality of transverse rigid pipes 9, preferably arranged orthogonally to the lines themselves.

The four-lines system also has the advantage (with respect to a single-line system) of being more stable and rigid (obviously preserving the required deformability, guaranteed by the joints, in order to adapt to the wave motion and to the safe non-uniform operation of the turbines, regarding both the ones arranged on a single line, and due to the difference between the turbines of the various lines).

The surface station, for example a ship, to which the single or the various lines for generating power are connected, is in turn anchored to the to the bottom of the sea through a suitable anchorage system (chains, blocks, etc). This should be capable of countering all the forces generated on the ship itself due to the presence of the fluid current and on the lines, (and thus transmitted to the ship) due to their resistance (thrust) developed by the turbines when the latter operate at full capacity.

1. System for generating electric power characterised in that it comprises
At least one line of turbines including a plurality of horizontal axis turbine devices (2), connectable to each other and positioned in a liquid current which determines their rotation,
A support structure, comprising float devices (5) adapted to keep such at least one line at a submerged operating position,
Rotation transmission devices which transfer the movement of the turbines to a surface means (8) provided with at least one electric generator connected to said at least one line.

2. System according to claim 1, comprising two lines parallel to each other.

3. System according to claim 1, comprising three lines parallel to each other substantially arranged to form a triangle.

4. System according to claim 1, comprising four lines parallel to each other substantially arranged to form a rectangle.

5. System according to claim 1, wherein each line comprises a plurality of horizontal axis turbine devices (2) mounted on single articulated axis (3) made up of various pieces or sections connected to each other by means of suitable joints.

6. System according to claim 5, wherein each turbine is rigidly connected to its axis by means of a hub (4) and each section of the axis is connected to the sections arranged ahead and behind it by means of cardan joints.

7. System according to claim 5, wherein each turbine device is supported by a special float (5) which is connected to the axis by means of a line (6) connected to a bearing.

8. System according to claim 5, wherein the rotation transmission devices for each line comprise at least one cardan joint and a rigid tubular element (7), which is connected to the electric generator arranged on such surface station.
